(19) United States
(12) Patent Application Publication
(10) Pub. No.: US 2026/0228514 A1
(43) Pub. Date: Aug. 6, 2026

(54) EFFICIENT AND ACCURATE POST-QUANTISATION OF ARTIFICIAL NEURAL NETWORKS

(71) Applicant: AXELERA AI BV, Eindhoven (NL)

(72) Inventors: BRAM VERHOEF, Eindhoven (NL); Evangelos Eleftheriou, Eindhoven (NL); Martino Dazzi, Eindhoven (NL); Saleh Ashkboos, Eindhoven (NL)

(21) Appl. No.: 19/148,412

(22) PCT Filed: Jan. 18, 2023
(86) PCT No.: PCT/EP2023/051137

§ 371 Date: Jul. 16, 2025

(51) Int. Cl. G06N 3/0495

(52) U.S. Cl. CPC G06N 3/0495

(57) ABSTRACT

The invention concerns a fast, accurate post-quantisation method of optimising an artificial neural networks (ANN), related systems, and computer program products. The method involves loading (S30) quantisation and neural parameters of the ANN, which include parameters that have been learned and quantised based on quantisation operations involving the quantisation parameters. It optimizes the ANN by: accessing (S31) labelled examples and executing (S33) the ANN on such examples; optimising (S34) the quantisation parameters; and accordingly updating (S35) the neural parameters. During the optimisation, the ANN is first executed (S33) on the labelled examples, based on current neural parameters to obtain inference results. Next, the quantisation parameters are optimised (S34) against an objective function computed according to the inference results and labels of the examples, keeping at least some of the current neural parameters fixed. Finally, the neural parameters are updated (S35) thanks to the quantisation operations, using the optimised quantisation parameters.

### TECHNICAL FIELD

The invention relates in general to the field of computer-implemented methods, computerised systems, and computer program products, for quantising artificial neural networks (ANNs). In particular, it is directed to methods optimising an ANN by optimising quantisation parameters and accordingly updating neural parameters of the ANNs. I.e., the quantisation parameters are optimised against an objective function computed according to inference results and labels of labelled examples of the training dataset, while keeping at least some (if not all) of the current neural parameters fixed.

### BACKGROUND

ANNs such as deep neural networks (DNNs) have revolutionized the field of machine learning by providing unprecedented performance in solving cognitive data-analysis tasks.

The main computational load of ANNs comes from multiply-and-accumulate (MAC) operations. In typical DNNs, several billions of MACs are performed per inference. Thus, MACs must as possible be performed efficiently. Quantising the ANNs simplifies the required computations and increases the efficiency of MAC operations. Indeed, quantising the ANN results in using lower bitwidth integer operands (e.g., INT8), as opposed to higher-bitwidth floating point operands (e.g., FP32) as typically used by a trained (yet non-quantised) ANN. Several types of neural parameters can be quantised, starting with the ANN weights. Quantisation improves the efficiency of the arithmetic operations, memory accesses, and storage.

However, after quantisation, the lower bitwidths of the operands usually decreases the accuracy of the ANN. Given that users do typically not want to compromise on the accuracy, it is desired to employ quantisation methods that preserve the accuracy of the ANN as much as possible.

Several quantisation methods have been developed. Two important classes of quantisation methods are the so-called post-training quantisation (PTQ) methods and quantisation-aware training (QAT) methods. PTQ methods are typically fast and easy to use. However, they often result in accuracy losses. QAT methods provide better results in terms of accuracy but are slow and difficult to use. Thus, there is ideally a need for fast, yet accurate quantisation methods, which should, if possible, additionally be user-friendly.

### SUMMARY

According to a first aspect, the present invention is embodied as a computer-implemented method of optimising an artificial neural network (ANN). The method first comprises loading quantisation parameters and neural parameters of the ANN. The loaded neural parameters include parameters that have been learned, by training the ANN, and quantised, based on quantisation operations involving said quantisation parameters. The method further comprises optimising the ANN by accessing labelled examples and executing the ANN on the labelled examples accessed, optimising the quantisation parameters, and accordingly updating the neural parameters. That is, during the optimisation of the ANN, the ANN is first executed on the labelled examples accessed, based on current neural parameters of the ANN. This way, inference results are obtained. Next, the quantisation parameters are optimised against an objective function, which is computed according to the obtained inference results and labels of the labelled examples, while keeping at least some of the current neural parameters fixed. Finally, the current neural parameters are updated thanks to said quantisation operations, based on the optimised quantisation parameters. The optimisation process is preferably iterated.

The above method is both accurate and fast in execution. It is fast because the optimisation performed during the second optimisation substep (corresponding to the backward pass) essentially concerns the quantisation parameters and merely requires, for the most part, arithmetic operations. The proposed method is nevertheless accurate because the optimisation of the quantisation parameters is end-to-end trained and indirectly causes to optimise the neural parameters (via the update step), which results in optimising the accuracy of the quantised ANN with respect to the training examples. Moreover, the present approach can support different quantisation techniques, whether uniform or non-uniform.

In embodiments, executing the ANN on the labelled examples further comprises quantising outputs of artificial neurons of internal layers of the ANN based on at least some of the quantisation parameters. The quantisation of neuron outputs requires additional work, even if such operations merely consist of arithmetic operations. However, this also makes the dependent operations more efficient: the neuron outputs are more efficiently accessed and processed by the subsequent ANN layers.

A remarkably simple approach is to use same quantisation parameters across the entire ANN. A judicious trade-off, however, is to define the quantisation parameters at the layer level. Thus, the quantisation parameters are preferably optimised independently for each neural layer of the ANN, whereby distinct sets of quantisation parameters are optimised for respective neural layers of the ANN.

In preferred embodiments, the quantisation operations comprise uniform affine quantisation operations (or, even, purely linear operations), which merely requires arithmetic operations that are efficiently performed. Such operations are typically followed by rounding operations. The quantisation operations may further include clipping outcomes of the rounding operations.

As noted above, the ANN is preferably optimised iteratively, by performing several algorithmic cycles, where each algorithmic cycle causes to perform steps as described above. Namely, the labelled examples are accessed, and the ANN is executed on the labelled examples accessed, according to current neural parameters of the ANN, to obtain inference results. Next, the quantisation parameters are optimised against the objective function (calculated according to the last inference results obtained), while keeping at least some of the current neural parameters fixed. Finally, the neural parameters are updated thanks to the quantisation operations, based on the optimised quantisation parameters.

Again, the outputs of artificial neurons of internal layers of the ANN are preferably quantised (upon executing the ANN, during each cycle), based on at least some of the quantisation parameters as optimised during a previous optimisation cycle.

Moreover, the quantisation operations may advantageously round outcomes of uniform affine operations during each algorithmic cycle, such that the updated neural parameters are rounded. In that case, the quantisation parameters can advantageously be optimised using a straight-through estimator during said each cycle.

The neural parameters to be updated may notably include ANN weights, which are already trained. I.e., in embodiments, the loaded neural parameters include ANN weights that have been learned prior to loading the quantisation parameters and the neural parameters of the ANN. Now, the method may focus on optimising a strict subset of the ANN weights, i.e., not all of the ANN weights, in the interest of efficiency. That is, the method may further comprise identifying a strict subset of the ANN weights (according to a given criterion) and then optimising the strict subset of the ANN weights identified against the objective function, in addition to optimising the quantisation parameters. Such ANN weights may be optimised during one or more of the several algorithmic cycles.

Different subsets of ANN weights may possibly be identified at different cycles. Alternatively, a strict subset of the ANN weights is identified as a static subset, once and for all, before or during one of the algorithmic cycles, e.g., before or during the very first algorithmic cycle. The selection criterion may for instance be defined so as for the identified ANN weights to be a fraction of the ANN weights that are the most impactful toward a selection objective, which is not necessarily the objective function as used to optimise the quantisation parameters (and the subset of ANN weights). Any “explainability” recipe can be used to that aim.

In other embodiments, all of the current neural parameters are kept fixed while optimising the quantisation parameters against the objective function. Albeit more efficient, such embodiments result in somewhat less accurate ANNs.

The present method may further train and quantise the ANN, prior to optimising it. That is, in preferred embodiments, the method further comprises training the ANN to learn the ANN weights (which will form part of the neural parameters as subsequently loaded for optimising the ANN) and quantising the neural parameters (or at least some of them), prior to loading the quantisation parameters and the neural parameters. To that aim, the quantisation parameters are first determined. Then, quantisation operations are performed based on the determined quantisation parameters. Such quantisation operations can for instance be of the same type as operations later performed during the optimisation. In embodiments, the quantisation parameters are determined according to a post-training quantisation algorithm. In variants, a quantisation-aware training algorithm is used to train the ANN and quantise the neural parameters of the ANN.

For example, the neural parameters can initially be quantised (i.e., prior to optimising the ANN) to an n-bit number representation, where, e.g., n=4, 8, or 16. Next, the ANN can possibly be optimised keeping the same n-bit number representation of the neural parameters. In variants, the optimisation causes to further quantise the neural parameters down to a lower bit representation or a distinct bit number representation.

In preferred embodiments, the loaded neural parameters include both ANN weights (which have been learned by training the ANN) and activation function parameters. Now, such parameters may be subjected to different quantisation goals. I.e., the neural parameters may possibly be updated (thanks to said quantisation operations), so as for the ANN weights and the activation function parameters to be respectively quantised to an n-bit number representation and an m-bit number representation, where m>n.

Various types of hardware devices may possibly be used to perform the optimisation. In particular, the ANN may possibly be executed by a neural processing apparatus (such as a device having a crossbar array structure), which is physically configured to implement one neural layer of artificial neurons at a time, while the quantisation parameters are optimised by one or more processing units (e.g., conventional processing units or a processing unit configured as a near-memory processing unit) in data communication with the neural processing apparatus. Involving one or more neural processing apparatuses will likely slow down the optimisation process. However, this option remains attractive where subsequent ANN inferences are to be made by the same types of neural processing apparatus(es), as this allows a more consistent optimisation to be achieved

According to another aspect, the invention is embodied as a computerised system. The system includes storage means storing labelled examples, as well as quantisation parameters and neural parameters of an ANN. Again, the stored neural parameters are parameters that are assumed to have been learned by training the ANN and quantised based on quantisation operations involving said quantisation parameters. The system further includes processing means, which are configured to instruct to load the quantisation parameters and the neural parameters of the ANN, and optimise the ANN in accordance with principles described above. I.e., in operation, this optimisation is achieved by accessing labelled examples and executing the ANN on the labelled examples accessed, based on current neural parameters of the ANN to obtain inference results. Next, the quantisation parameters are optimised against an objective function computed according to the obtained inference results and labels of the labelled examples, while keeping at least some of the current neural parameters fixed. Finally, the current neural parameters are updated thanks to said quantisation operations, based on the optimised quantisation parameters.

According to a final aspect, the invention is embodied as a computer program product for optimising an ANN. The computer program product comprises a computer readable storage medium having program instructions embodied therewith. The program instructions are executable by processing means of a computerised system to cause the latter to perform the steps of any of the methods discussed above.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIGS. 1 and 2 are flowcharts illustrating high-level steps of a post-training quantisation (PTQ) method and a quantisation-aware training (QAT) method, respectively. Such methods can for instance be used to train and quantise an artificial neural network (ANN), prior to optimising such an ANN in accordance with embodiments. Note, PTQ and QAT algorithms are known per se, even though FIGS. 1 and 2 are, as such, not prior art. Rather, the flows depicted in FIGS. 1 and 2 capture possible, high-level implementations of PTQ and QAT algorithms, to the understanding of the present inventors;

FIG. 3 is a flowchart illustrating high-level steps of a method of optimising an ANN, according to embodiments. The initial quantisation step may possibly be performed according to any of the PTQ and QAT methods captured in the flows of FIGS. 1 and 2;

FIGS. 4A-4C are diagrams of artificial neurons, illustrating how neuron outputs can be quantised (as in FIGS. 4B and 4C) or not (FIG. 4A), by effectively inserting a quantisation node at the output of the neuron (as in FIG. 4B and FIG. 4C), as in embodiments. Additional quantisation nodes may be provided to quantise the weights (as in FIG. 4C), if necessary;

FIG. 5 schematically represents a computerised system, suited for implementing steps according to the present methods, according to embodiments; and

FIG. 6 schematically represents a general-purpose computerised unit, suited for implementing one or more method steps (in particular the ANN optimisation steps), according to embodiments of the invention.

The accompanying drawings show simplified representations of concepts, systems, devices, or parts thereof, as involved in embodiments. Similar or functionally similar elements in the figures have been allocated the same numeral references, unless otherwise indicated.

Computerised systems, methods, and computer program products embodying the present invention will now be described, by way of non-limiting examples.

### DETAILED DESCRIPTION OF EMBODIMENTS OF THE INVENTION

The following description is structured as follows. General embodiments and high-level variants are described in section 1. Section 2 addresses particularly preferred embodiments, including preferred flows of operations. Section 3 concerns technical implementation details.

### 1. GENERAL EMBODIMENTS AND HIGH-LEVEL VARIANTS

### 1.1 Computer-Implemented Methods

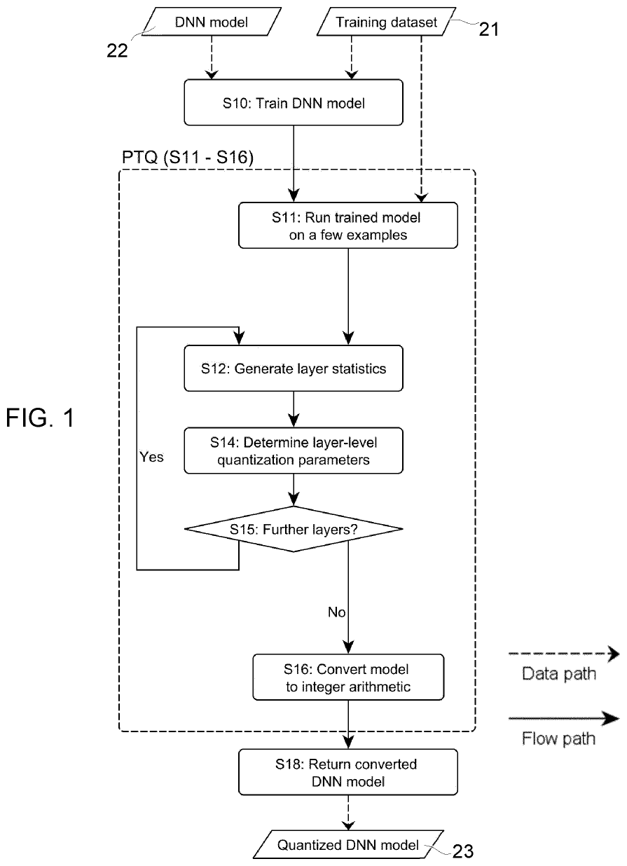

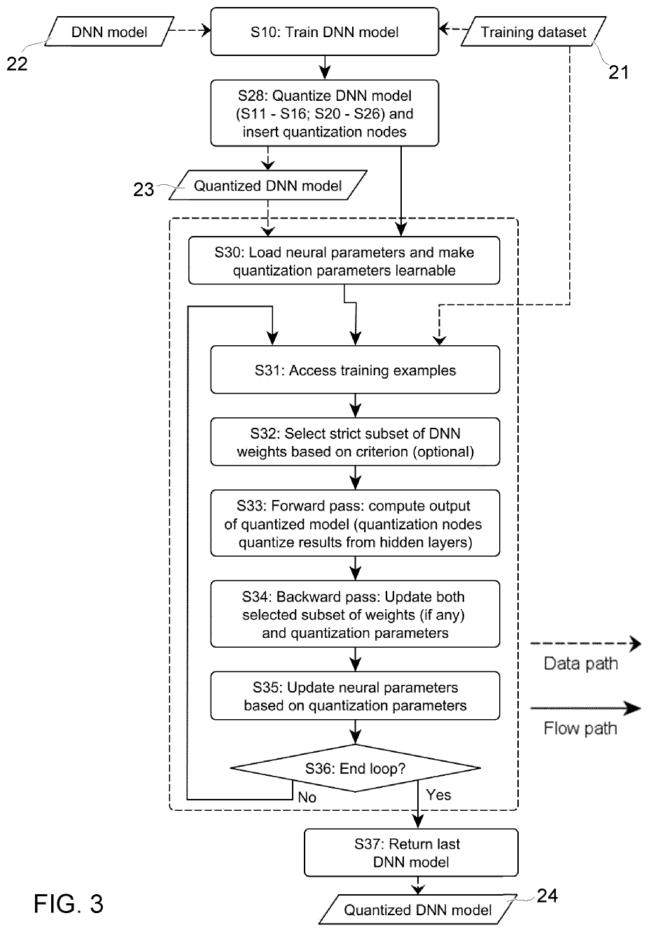

A first aspect of the invention is now described in detail in reference to FIG. 3. This aspect concerns a computer-implemented method of optimising an artificial neural network (ANN) 23. This method and its variants are collectively referred to as the “present methods” in this document. All references Sn refer to methods steps of the flowcharts of FIGS. 1-3, while numeral references pertain to devices and systems, or parts thereof, as well as concepts, as involved in embodiments of the present invention.

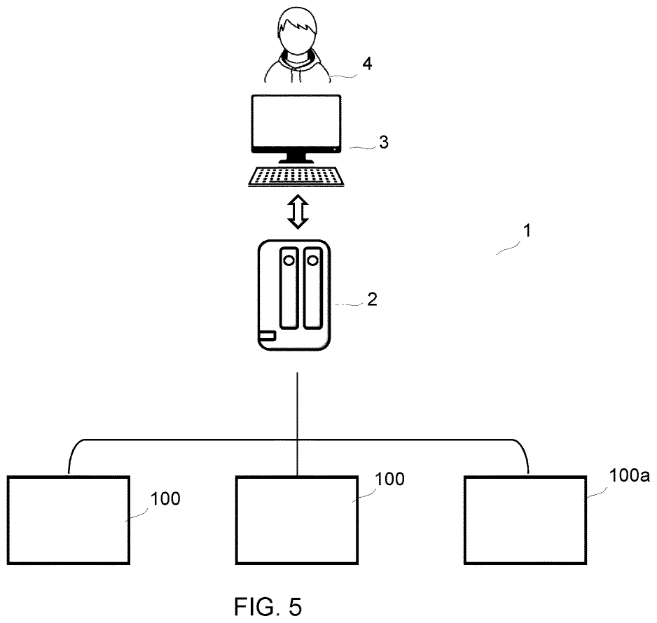

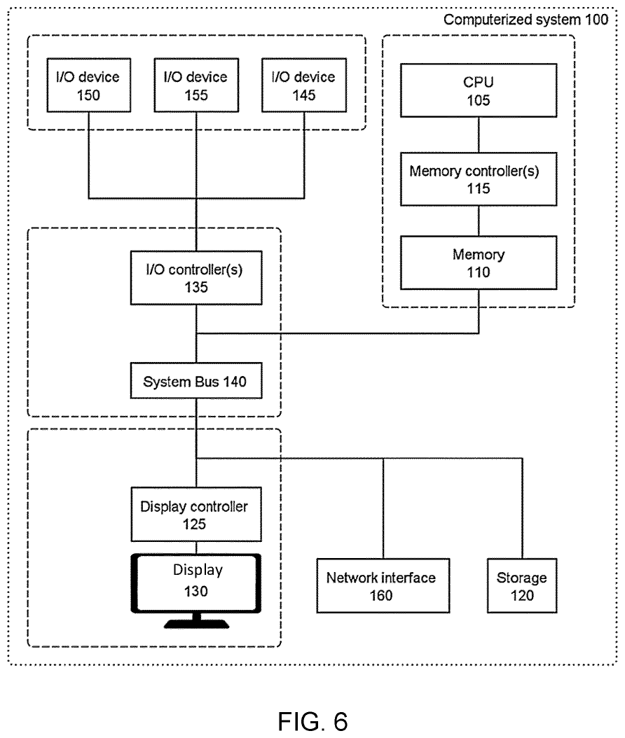

The method is performed by a computerised system 1 (see, e.g., FIG. 5), which may include one or more computerised units 100 such as shown in FIGS. 6 and 7. The method can be executed using one or more general-purpose computerised units 100, possibly a conventional computer (see FIG. 6) or a set of conventional computers. The method may further involve dedicated processing hardware. The underlying computerised system 1 concerns another aspect of the invention, which is described later in detail.

Assume, for now, that the ANN has already been trained and that it has further already been quantised. In that case, the method first comprises loading quantisation parameters and neural parameters of the ANN 23, see step S30 in the flow of FIG. 3. The neural parameters may include ANN weights and/or activation function parameters (also referred to as activation parameters herein), i.e., parameters used by the activation functions, if any. Thus, the quantisation parameters include parameters that can be used for quantising the neural weights and/or the activation function parameters. As per the above assumption, the ANN weights have already been learned S10 by training the ANN. In addition, the neural parameters have further been quantised (step S28) based on quantisation operations.

The method further comprises optimising the ANN, something that is achieved by essentially performing four steps, corresponding to steps S31, S33, S34, and S35, in the flow of FIG. 3. This optimisation is now described in detail.

First, the optimisation requires accessing S31 labelled examples S22 or S31 of a training dataset and executing S33 the ANN 23 on the labelled examples S22 or S31 accessed, to obtain inference results. The training dataset includes labelled examples (also called training samples), which form input-output pairs of the form {input data→label}. Yet, the forward pass just requires executing S33 the ANN on the input data part of the labelled examples 21. The label part is later used by the objective function, see below. During the forward pass, the ANN is executed S33 based on current neural parameters of the ANN. Note, the labelled examples 21 may possibly be loaded, all at once, in the main memory of the computerised system (the memory permitting), whereby such labelled examples 21 can be directly accessed S31 upon executing S33 the ANN 23. In variants, such examples 21 are iteratively accessed, or accessed in batches, with a view to executing the ANN thereon to perform inferences.

Second, the optimisation of the ANN causes to optimise S34 the quantisation parameters against an objective function (backward pass). The latter is computed according to both the obtained inference results and labels of the labelled examples. I.e., the objective function compares inference results with the labels, in order to measure the accuracy (or a related quantity) of the inferences performed by the ANN. However, in the present context, the primary purpose of the objective function is to optimise the quantisation parameters and not the ANN weights (this is assumed to have already been done earlier). In fact, at least some (possibly all) of the current neural parameters are kept fixed while optimising S34 the quantisation parameters. A (small) fraction of the neural parameters may possibly be optimised during the backward pass, along with the quantisation parameters.

Third, the current neural parameters are subsequently updated S35 thanks to the quantisation operations evoked above, based on the quantisation parameters as optimised at step S34. This gives rise to new (i.e., updated) neural parameters, which may possibly be used as new current parameters during a subsequent algorithmic cycle of optimisation, if any. Updating S35 the neural parameters causes to indirectly optimise them, thanks to the quantisation operations.

The proposed method can be regarded as a post-quantisation, post-training methodology for optimising quantisation parameters and accordingly updating neural parameters (i.e., ANN weights and/or activation function parameters), inasmuch as the initial neural parameters are assumed to be already trained and quantised. The proposed method focuses on optimising the quantisation parameters against an objective function (comparing inference results to labels), whereas at most a strict subset of the neural parameters are being optimised along with the quantisation parameters during the backward pass. In embodiments, the neural parameters are in fact not trained at all. However, the neural parameters are indirectly optimised, thanks to the update step S35.

Comments are in order. As explained above, the objective function is computed according to the obtained inference results and the labels. The inference results are outputs from the whole ANN, as obtained upon executing the whole ANN. Such inference results differ from feature maps and other data that may possibly be extracted from internal layers of the ANN. Similarly, such inference results differ from statistics that may possibly be obtained from internal ANN layers. Thus, the objective function compares outputs of the whole network against the labels, i.e., the ground truth.

The objective function is typically defined as a loss function (e.g., a squared loss) or a cost function (e.g., a mean squared error), aiming at improving a performance of the ANN, whether, e.g., its accuracy, precision, F1-score, or any useful metric of interest. In preferred embodiments, the chosen metric is a proxy for accuracy. For example, this metric can be a cross-entropy between softmax outputs of a classification network and the labels of the training dataset. However, it should be emphasised that steps S31-S34 do not directly optimise against accuracy (or the chosen metric). I.e., the optimisation is indirect. Also, this objective function does not compare quantised and non-quantised versions of the ANN. Rather it compares outputs from the whole ANN (as quantised) to the ground truth, with a view to accordingly optimising the quantisation parameters and updating the neural parameters. That is, the present solution relies on labelled data to optimise the quantisation parameters against the objective function. Thus, the proposed approach conceptually differs from methods that train quantisation parameters on unlabelled data, using an objective function comparing quantised and non-quantised versions of the ANN.

Quantising means passing from a certain bit representation (e.g., single-precision floating-point format, or FP32) to a lower bit representation (e.g., 8-bit floating point [FP8] or 8-bit integer [INT8] format). I.e., quantisation refers to the process of reducing the number of bits used to represent the numbers (here the neural parameters). This process leads to a change of the numerical format. The quantisation may only concern a part of the represented number. For example, a floating-point number may be quantised to change the number of bits allocated to the mantissa or the exponent between the two floating point formats. Still, the overall number of bits may possibly remain unchanged. I.e., one part of the number (e.g., exponent or fraction) may be quantised to a lower bit width, while another part of this number is expanded. In usual applications, however, quantising numbers leads to decrease the global number of bits.

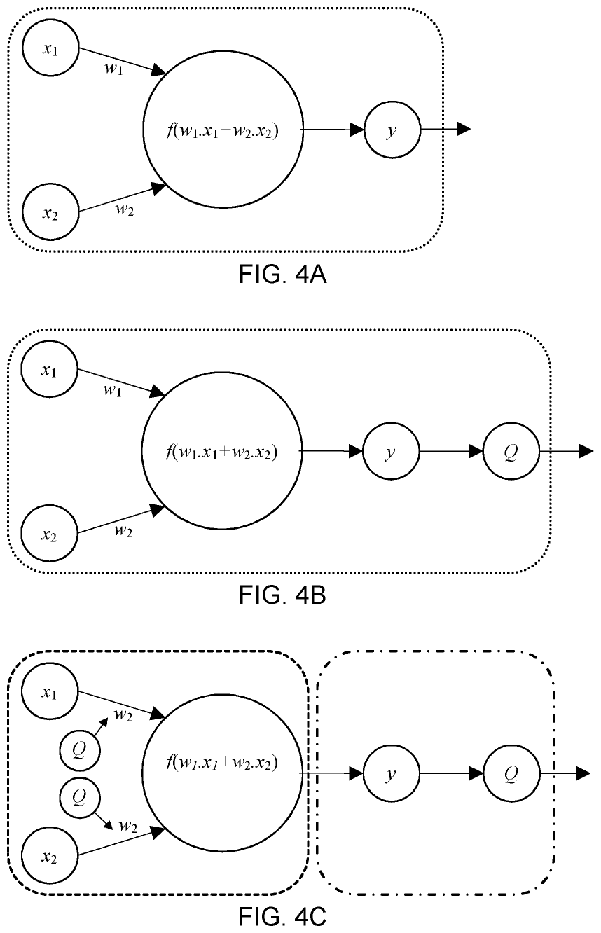

As said, the neural parameters that come to be updated S35 may include ANN weights and/or activation parameters. In typical embodiments, such parameters include at least the weights of the ANN, whereby the ANN weights are updated at step S35. The activation parameters may optionally form part of the neural parameters to be updated S35, though activation parameters do not necessarily need to be quantised when quantising ANN weights or may be quantised to a different bit representation than the weights. In fact, the activation functions are themselves optional in an ANN. I.e., the ANN preferably, but not necessarily, involves activation functions (compare FIGS. 4A, 4B, and 4C). Note, for completeness, that the ANN weights are always learned (here during the initial training S10 of the ANN), while activation parameters used in the activation functions are typically not learned.

The present methods apply to any type of ANNs, such as ANNs having a feedforward architecture (including convolutional neural networks), recurrent networks, transformer networks, spiking neural networks, i.e., any network that may potentially benefit from quantisation.

The proposed methodology may initially rely on a standard algorithm (e.g., a PTQ or QAT algorithm) or an off-the-shelf algorithm, thanks to which an initial set of quantisation parameters (e.g., scale and offset parameters) is obtained. This algorithm may for example use calibration data to greedily optimise the quantisation parameters for each ANN layer. Such quantisation parameters are then optimised S34, and the optimised quantisation parameters are finally used to update the neural parameters (e.g., weights and/or activation parameters). Still, the present post-quantisation technique may only be applied to a subset of the parameters governing the ANN. In particular, the present approach may possibly be applied only to a subset of the ANN weights, e.g., the weights of selected ANN layers or, even, only a subset of the ANN weights of one or more of the ANN layers. In all cases, however, the present approach causes to modify neural parameters, as represented in the memory (when performing the optimisation), and as subsequently stored in the persistent storage of the computerised system 1. I.e., the result of quantisation requires less memory storage and access. And, eventually, the optimised ANN can be used to perform inferences more efficiently.

Unlike quantisation methods such as the so-called PTQ algorithm, the present approach allows the quantisation to be optimised in a non-greedy way, using any suitable objective function, as long as this function compares inference results to the ground truth. Moreover, the quantisation is achieved at a lower computational cost than with QAT-like methods and the backward pass has lower memory requirements than QAT-like methods because the latter optimise all neural parameters together with the quantisation parameters during the backward pass.

Accordingly, the proposed method is, in principle, faster than QAT-like methods and more accurate than PTQ-like methods. It is fast because the optimisation performed during the backward pass (step S34) essentially concerns the quantisation parameters. The quantisation parameters are less numerous than the ANN weights. Plus, the optimisation of the quantisation parameters merely requires arithmetic operations in practice. In addition, a substantial part of the neural parameters are frozen during the backward pass. This way, the quantisation parameters are quickly refined, while the neural parameters are subsequently updated S35 in a straightforward manner, in accordance with the quantisation parameters as optimised S34 last. Thus, the present method makes it possible to efficiently optimise a quantised ANN.

The proposed method is nevertheless accurate because the optimisation of the quantisation parameters indirectly causes to optimise S35 the neural parameters. This results in optimising the accuracy of the quantised ANN with respect to the training examples (unlike PTQ-like methods). That is, the optimisation S34 of the quantisation parameters takes into account the training dataset, like QAT methods. PTQ-like methods too can be devised to make use of data indirectly obtained from part or all of the training dataset, as part of the calibration step S12 in FIG. 1. However, PTQ-like methods do not rely on outputs from the whole ANN to construct the objective function and thus do not make it possible to optimise the ANN accuracy to the same extent the present approach does.

So, the present approach provides a welcome trade-off between PTQ-like and QAT-like methods. Moreover, a further advantage of the present approach is that it can support different quantisation techniques, whether uniform or non-uniform.

All this is now described in detail, in reference to particular embodiments of the invention. To start with, the execution S33 of the ANN (forward pass) preferably involves a quantisation of the neuron outputs, i.e., outputs from the artificial neurons of internal layers of the ANN. That is, not only the ANN weights are being quantised, but, in addition, the internal (hidden) layer node outputs are quantised too.

The quantisation of the neuron outputs is based on at least some of the quantisation parameters as loaded at step S30. I.e., only a subset of the loaded quantisation parameters may be needed for this operation. Preferably, distinct subsets of the quantisation parameters are used to quantise neuron outputs of the ANN layers, activation parameters, and ANN weights. Note, in the flow of FIG. 3, the quantisation of the neuron outputs intervenes S33 before step S34. However, this quantisation can be based on quantisation parameters as optimised during a previous algorithmic cycle (if any). In variants, the quantisation of the neuron outputs relies on static quantisation parameters (meaning that the corresponding quantisation parameters are not optimised at step S34).

The quantisation of neuron outputs requires additional work, even though such operations merely consist of arithmetic operations. However, quantising the internal layer outputs makes the dependent operations more efficient. As illustrated in FIGS. 4B and 4C, the quantisation of the neuron outputs amounts to adding quantisation nodes to the ANN, at the output of each neuron. In the example of FIG. 4B, a node “Q” is placed directly at the neuron output (corresponding to node “y”). Note, in the examples of FIGS. 4A-C, the linear operation performed by a neuron and the activation function ƒ(·) are represented as a single node. In the example of FIG. 4C, further quantisation nodes are provided to quantise the weights used as inputs to the neuron, in addition to the quantisation node placed at the neuron output. On the contrary, no quantisation is performed in the example of FIG. 4A.

In general, one may contemplate various mappings (i.e., partitions) of quantisation parameters to the neurons. A remarkably simple approach is to use same quantisation parameters for all the ANN neurons irrespective of the layers they belong to. Conversely, distinct sets of quantisation parameters can be assigned to respective subsets of artificial neurons. In practice, a satisfactory trade-off is to use the same quantisation parameters across a same layer of the ANN. E.g., same parameters are used for the entire tensor of one layer but different quantisation parameters are used for different layers of the ANN. That is, the ANN layers are associated with respective sets of quantisation parameters. So, in embodiments, the quantisation parameters are independently optimised S34 for each neural layer of the ANN, whereby distinct sets of quantisation parameters are obtained for respective ANN layers.

More generally, the quantisation parameters can be subject to various trade-offs. E.g., the quantisation parameters can be defined at the ANN level, at the layer level (each layer has its own quantisation parameters, but the quantisation parameters differ from one layer to the next, as exemplified just above), or on other sub-units of the ANN. For example, in convolutional neural networks (CNNs), one may use different quantisation parameters for each channel.

In embodiments, the quantisation operations include, or possibly consist of, uniform affine quantisation operations. This merely requires arithmetic operations, which are efficiently performed. Preferably, the quantisation operations further involve rounding outcomes of the uniform affine quantisation operations. In turn, the outcomes of the rounding operations can possibly be clipped, if necessary. For example, the quantised value ā of an initial value a may be obtained as ā=clip(round(a/s+z)), whereby the quantisation transformation is uniquely defined by the quantisation parameters s and z. Note, the quantisation parameters may possibly be processed through specific functions. That is, in the above formula, s and z may possibly be obtained through other formulas, i.e., s=g(s′) and z=h(z′). Various rounding methods may be used (e.g., based on the called floor or ceiling function, or a function rounding to the nearest integer). In addition, the quantisation algorithms may for example optimise the range of real values that get converted to the integer domain. Beyond quantisation to integers, however, the present methods may possibly be used to achieve any bit representation that is lower than the initial bit representation (as used to initially train the ANN) or transform the number representations, as explained earlier.

In variants to uniform affine quantisation operations, the quantisation may for instance rely on purely linear operations (i.e., z=0). More generally, various quantisation methods are known, which primarily rely on arithmetic operations, subject to subsequent rounding and clipping operations. All such quantisation methods can thus benefit from the present post-quantisation approach.

As noted earlier, the ANN can possibly be optimised iteratively (see the loop S31-S35-S31 in FIG. 3). This amounts to performing several algorithmic cycles, where each algorithmic cycle comprises: (i) accessing S31 the labelled examples 21 and executing S33 the ANN on the labelled examples 21 (according to current neural parameters) to obtain inference results; (ii) optimising S34 the quantisation parameters against the objective function (as calculated according to the inference results obtained, while keeping at least some of the current neural parameters fixed); and (iii) updating S35 the neural parameters thanks to said quantisation operations, based on the quantisation parameters optimised last. Again, the neuron outputs are preferably quantised too, albeit based on quantisation parameters as optimised during a previous cycle.

The quantisation operations may again include rounding operations, during each algorithmic cycle, such that the updated neural parameters are rounded. Now, as it may be realised, the rounding function may cause all gradients to be zero. In such a case, it is judicious to use a straight-through estimator. That is, after rounding the neural parameters during a given algorithmic cycle, the quantisation parameters can be optimised S34 using a straight-through estimator during the backward pass. This estimator computes the gradients as if the rounding function was the identity function. In variants, gradient-free optimisation algorithms may be used to refine the quantisation parameters, such as methods based on evolutionary algorithms.

In embodiments, a small (strict) subset of the ANN weights are additionally optimised, during one or more (possibly each) of the algorithmic cycles. That is, a strict subset of the ANN weights may be identified at step S32, according to a given selection criterion. This subset is then optimised S34 against the objective function, in addition to optimising the quantisation parameters. In that case, a dual optimisation is performed. However, the fraction of optimised ANN weights is preferably kept small.

The selection criterion can for instance be defined so as for the identified ANN weights to be a small fraction of the ANN weights that are the most impactful toward a given objective, which is not necessarily the same as the objective function used to optimise the quantisation parameters (and the identified weight fraction). Various explainability recipes can be used to identify the ANN weights, such as based on Shapley values or influence functions, or any other method that makes it possible to evaluate marginal contributions of the ANN weights to the given objective. Another possibility is to use the L₁-norm or L₂-norm (or any other norm Lₚ) of an array corresponding to a filter in a CNN. The top fraction of the ANN weights identified preferably concerns less than 50% of the ANN weights, more preferably less than 20%. For example, the optimised ANN weight fraction may be limited to the top 10% weights.

In practice, the identification and optimisation of this subset of ANN weights can be performed during a single algorithmic cycle (e.g., the first or last algorithmic cycle), or during each of several algorithmic cycles. These operations are preferably performed at least during the first algorithmic cycle. The identified subset of ANN weights can be a static subset, e.g., as identified, once and for all, during the first algorithmic cycle. The same ANN weights are then relied upon for optimisation during the subsequent cycles.

In variants, all of the neural parameters are kept fixed during the backward pass S34. I.e., the optimisation S34 solely concerns the quantisation parameters. Notwithstanding, the ANN weights are indirectly optimised due to the update operation S35 based on the optimised quantisation parameters. Albeit more efficient, this variant may result in somewhat less accurate ANNs.

The assumption so far is that the ANN fed as input to the method has already been trained and quantised. Now, the present methods may include preliminary steps of training S10 and quantising S28 the ANN, prior to loading S30 the quantisation parameters and the neural parameters. That is, the ANN may be trained (step S10, FIG. 3) based on a suitable training dataset, to learn the ANN weights. In specific embodiments, some or all of the activation parameters may initially be learned S10 too. Note, the training dataset used at step S10 may possibly differ from (e.g., be a superset or a subset of) the training set used for the optimisation S31-S35. Preferably, though the same training dataset is used at step S10 and at steps S31-S35. At least some of the neural parameters are quantised at step S28. This quantisation is achieved by first determining suitable quantisation parameters and then performing quantisation operations based on the determined quantisation parameters. Preferably, step S28 relies on the same quantisation parameters and the same types of quantisation operations as subsequently used at steps S31-S35, it being nevertheless noted that the actual values of the quantisation parameters will likely change as a result of the optimisation S34.

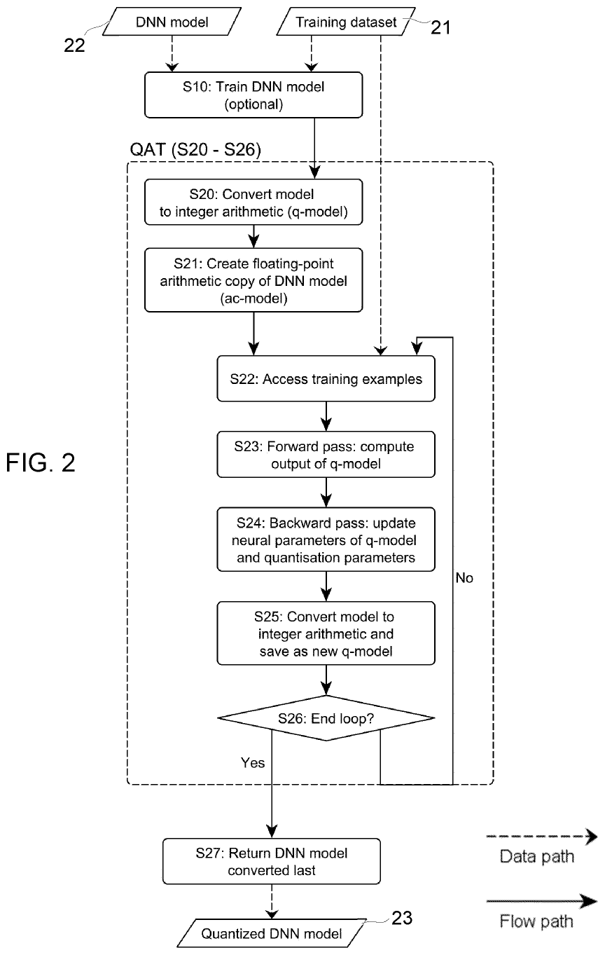

More generally, though, the preliminary quantisation S28 may be based on any suitable quantisation algorithm. For instance, step S28 may actually consist of steps S11-S16 or steps S20-S26 as shown FIGS. 1 and 2. In particular, the quantisation parameters may be determined S28 according to a PTQ algorithm (S11-S16, FIG. 1), so as to initially quantise the ANN according to the PTQ algorithm. In variants, a QAT approach (S20-S26, FIG. 2) is initially used to train and quantise the network.

For example, step S28 may convert the initial ANN 22 (e.g., relying on a single-precision floating-point format, FP32) to a quantised version 23, e.g., having a minifloat (FP8) format or an integer format (e.g., INT8) 23. More generally, the neural parameters will preferably be quantised S28 to an n-bit number representation, where n=4, 8, or 16. The same number representation can then be used during the post-quantisation optimisation steps S31-S35. That is, in preferred embodiments, the ANN is subsequently optimised S31-S35 keeping the same n-bit number representation of the neural parameters. In variants, the post-quantisation optimisation steps may quantise the neural parameters down to a lower bit representation or a distinct format, as explained earlier.

These are just examples, of course. Other types of quantisation strategies may possibly be devised, depending on the intended application. For example, assume that neural parameters (as loaded at step S30) include both ANN weights (which have been learned at step S10) and activation function parameters, where the neural parameters have already been quantised S28 to an n-bit number representation. Then, at step S35, the neural parameters can possibly be updated S35 (thanks to quantisation operations evoked earlier), so as for the ANN weights and the activation function parameters to be respectively quantised to an n-bit number representation and an m-bit number representation, where m>n. For example, {n, m} can be equal to {4, 8} or {8, 16}. Going further, the neuron outputs (or the outputs of the activation function nodes) may possibly be quantised to a k-bit number representation, where k>m>n. In simpler variants, however, n is equal to m (e.g., n=m=8). Similarly, one may impose k=n=m, as implicitly assumed earlier. However, it can be advantageous to impose m>n or, similarly, k>m>n, to minimise the impact of quantisation on the neuron outputs. For that same reason, some may prefer not to quantise the activation parameters and outputs of the activation function nodes. In principle, though, any number representation may be contemplated for the ANN weights, the activation function parameters, and the neuron outputs, even k<m<n.

The optimisation steps S31-S35 can typically be performed by a single computerised unit 100, such as the unit 100 shown in FIG. 6. In variants, step S33 is performed using a special-purpose processing unit. This unit may for instance be a neural processing apparatus, which is physically configured to implement one neural layer of artificial neurons at a time. E.g., the ANN can be executed S33 by a neural processing hardware having a crossbar array structure. In that case, the forward pass requires multiple iterations through the same crossbar array structure. Another possibility is to use cascaded crossbar arrays. That is, outputs from one crossbar array can either be passed to the same crossbar array or a further crossbar array (cascaded), to trigger the execution of another neural layer, and so on.

When using a crossbar array (not shown), the neuron outputs of each ANN layer are processed by a separate processing unit, be it for computing activation functions (on the forward pass) and optimising S34 the quantisation parameters (on the backward pass). This separate processing unit will much preferably be “close” to the neural processing hardware. That is, this processing unit is preferably configured as a near-memory processing device, considering the neural processing hardware as a memory storing neuron outputs.

Involving one or more neural processing apparatuses will likely slow down the optimisation process. However, this option remains attractive where subsequent ANN inferences are to be made by the same types of neural processing apparatus(es), as this allows a more consistent optimisation to be achieved. I.e., the optimisation of the quantisation parameters takes into account the behaviour of the same apparatus(es) as subsequently used for inference purposes. In addition, this approach lends itself well to the optimisation of distinct sets of quantisation parameters for respective neural layers of the ANN. In preferred embodiments, however, conventional computer hardware is used to perform the optimisation S31-S35, while special-purpose hardware such as crossbar arrays are only used for subsequent inference purposes.

### 1.2 Other Aspects of the Invention

In that respect, another aspect of the invention is now described in reference to FIGS. 5 and 6, which aspects concerns a computerised system 1. The system 1 may include several computerised units 2, 100. The latter typically consist of conventional computerised units, a general architecture 100 of which is shown in FIG. 6. However, the system 1 may further include one or more non-conventional units, such as neural processing apparatuses involving crossbar array devices, be it for inference purposes, as discussed above.

The optimisation of the ANN is preferably performed by a single computerised unit 2, 100, which includes storage means 120. The latter may notably store labelled examples 21, as well as quantisation parameters and neural parameters of an ANN 23, where the neural parameters are parameters that have been learned and quantised, as described earlier. The computerised unit 2, 100 further includes processing means 105, which are configured to perform steps as described earlier in reference to the present methods. I.e., the processing means 105 may notably be configured to load quantisation parameters and neural parameters of the ANN, and subsequently optimise the ANN according to methods described in Sect. 1.1. This, in practice, typically requires loading computerised methods (initially stored in the form of software) in the main memory 110 of the computerised unit 2, 100, with a view to executing corresponding software instructions, as further discussed in Sect. 3.

A final, yet related aspect of the invention concerns a computer program product for optimising an ANN. The computer program product comprises a computer readable storage medium having program instructions embodied therewith, where the program instructions are executable by processing means 105 of a computerised system 1, 2, 100 to cause the latter to perform steps according to the present methods. Section 3 discusses additional features of the present computerised systems 1 and computer program products.

The above embodiments have been succinctly described in reference to the accompanying drawings and may accommodate a number of variants. Several combinations of the above features may be contemplated. Examples are given in the next sections.

### 2. PARTICULARLY PREFERRED EMBODIMENTS (PREFERRED FLOWS AND GRAPHICAL USER INTERFACE)

### 2.1 Preferred Flows

FIG. 3 captures a preferred flow. A deep neural network (DNN) model 22 is initially trained S10 based on inputs that include a data structure of the DNN model and a training dataset 21. A preliminary quantisation is performed at step S28, which concerns neural parameters of the DNN. This quantisation may possibly be based on a standard quantisation approach, such as a PTQ method (steps S11-S16, FIG. 1) or the QAT method (steps S20-S26, FIG. 2). A quantised DNN model 23 is accordingly obtained. Note, quantisation nodes can be inserted in the DNN model, in fine, with a view to subsequently quantising neuron outputs too, upon executing the DNN.

At step S30, the neural parameters of the DNN are loaded in the main memory of a computerised unit 100, together with initial values of the quantisation parameters. The DNN data structure and the learning algorithm are further prepared to ready the quantisation parameters for the subsequent optimisation process S31-S35 (i.e., to make the quantisation parameters learnable).

The optimisation starts at step S31. The training examples are accessed at step S31, as necessary to perform S33 forward passes and obtain corresponding outputs of the DNN model, i.e., outcomes of inferences on the input part of the training examples. The inserted quantisation nodes happen to quantise the neuron outputs (including outputs from nodes of hidden DNN layers). The backward pass S34 causes to update the quantisation parameters and optimise a selected subset of the DNN weights. This subset of weights can for instance be identified at step S32 (i.e., right after or concomitantly with step S31), based on a given selection objective, for subsequent optimisation. Distinct subsets of DNN weights may be identified S32 during each algorithmic cycle, as assumed in FIG. 3. In variants, the subset of DNN weights is identified beforehand as a static subset, i.e., once and for all, and before the start of the very first algorithmic cycle.

The neural parameters are updated S35 based on the latest values of the quantisation parameters, i.e., the quantisation parameters as optimised last. As noted above, the optimisation process is preferably iterated S36, until a certain termination criterion is met (S36: Yes). If so, the DNN model 24 as optimised last is returned S37. Else (S36: No), another algorithmic cycle is started, causing to further optimise S34 the quantisation parameters and accordingly update S35 the neural parameters. The process repeats until the termination condition is met. Further iterations may be subjected to a user approval, who may be given the opportunity to inspect various performance indicators, before deciding to further the optimisation process. Note, the unit 100 may proactively generate deployment-ready versions of the successively updated DNN models. This way, the user may, at any time, decide to stop the optimisation process and download any version of the optimised ANN model.

The preliminary quantisation S28 can for instance be performed according to the PTQ approach (FIG. 1). In that case, a DNN model 22 may initially be trained S10, based on a training set 21, prior to starting the post-training quantisation algorithm S11-S16. At step S11, the trained model is run on a few examples (extracted from the training set 21), with a view to extracting layer statistics. Layer statistics are generated S12 for each layer, based on which layer-level quantisation parameters are determined at step S14. Steps S12 and S14 are repeated (S15: Yes) for each layer. After that (S15: No), the model is converted S16, e.g., to an integer arithmetic model and the converted model 23 is returned at step S18. This model 23 can then be used as input to step S30.

In variants, the preliminary training S10 and quantisation S28 are performed according to the QAT approach. In that case, a DNN model 22 may initially be trained S10, based on a training set 21, prior to starting the quantisation-aware training algorithm S20-S26. At step S20, the model is converted to, e.g., an integer arithmetic model (noted q-model). A floating-point arithmetic copy of the DNN model (noted ac-model) is created at step S21. Training examples are accessed at step S22. The output of the q-model is computed S23 during the forward pass. During the backward pass S24, the neural parameters (weights) of the q-model are updated. The quantisation parameters may possibly be updated too at step S24, although not all QAT algorithms make this possible. At step S25, the model is converted to an integer arithmetic model and saved as a new q-model. The process repeats (S26: No) until a termination criterion is met. If so (S26: Yes), the DNN model 23 as converted last is returned S27. This model 23 can then be used as input to step S30.

### 2.2 Performance Evaluation

Table 1 below shows results obtained for several ANNs and training datasets, thanks to the method of FIG. 3, where the method relies on an initial PTQ quantisation, subsequently optimises S34 the quantisation parameters, and accordingly updates S35 the ANN weights in an iterative manner, without retraining any of the ANN weights. The method further quantises the neuron outputs (as in FIG. 4C). This table shows that the present approach can achieve better accuracy than the standard PTQ algorithm. What is more, it can even improve over the original full-precision model.

TABLE I
comparison of results obtained

| | | | Present |
|---|---|---|---|
| | Original | PTQ | method |
| | Accuracy | Accuracy | accuracy |
| Model/Dataset | [%] | [%] | [%] |
| MobileNet v1/ImageNet | 70.34 | 69.03 | 70.448 |
| TFLite MobileNet v1/ImageNet | 71.24 | 69.88 | 70.88 |
| ResNet50/ImageNet | 76.14 | 76.07 | 76.13 |
| ResNet20/CIFAR100 | 58.24 | 56.86 | 62.36 |

Further tests conducted by the inventors with the MobileNet v1 network on the ImageNet dataset have shown that the accuracy of the present approach is on par with or better than the accuracy obtained with the full-precision accuracy (FP32), and thus also better than the accuracy obtained with a standard PTQ algorithm, for several hyper-parameter settings.

### 2.3 Graphical User Interface

The present methods may advantageously run a graphical user interface (GUI), to enable interactions with users. The GUI may for instance be run from the server 2 in FIG. 5. This GUI essentially aims at allowing the user 1 to select and/or upload training datasets and ANN models, select an objective function and a selection objective (to identify the subset of ANN weights to be refined, if any). In addition, the GUI may be designed so as to allow the user to open an assistant to inspect the performance of the optimised ANN models. Several evaluation metrics may be relied on. E.g., while the primary objective may be accuracy, secondary metrics may be displayed too, such as a F1 score, a precision score, and a balanced accuracy, for example.

In addition, the GUI may further be used to export trained ANN models. In general, the present methods may generate and store deployment-ready versions of the optimised ANNs, as noted above. In particular, after optimising a given ANN, the present methods may generate a deployment-ready version thereof and display performance indicators of the optimised ANN to the user. The GUI may otherwise be designed to allow the user to export (e.g., download) the deployment-ready version of the optimised ANN.

### 3. TECHNICAL IMPLEMENTATION DETAILS

Computerised devices can be suitably designed for implementing embodiments of the present invention. It can be appreciated that the methods described herein are essentially non-interactive, i.e., automated. Such methods are typically implemented as a combination of software and hardware. Sections 3.1 and 3.2 address possible hardware configurations. Section 3.3 specifically concerns computer program products, while section 3.4 compounds final remarks.

### 3.1 Preferred System Configuration (FIG. 5)

FIG. 5 illustrates a computerised system configured as a network 1 interconnecting several computerised units 2, 3, 100. In this example, the system 1 includes a server 2, which interacts with clients 4, who may be natural persons (interacting via personal computers 3), processes, or machines. In addition, the server 2 is configured to offload computation tasks to attached computerised devices 100, 100a.

The computerised devices 100, 100a typically include conventional hardware 100, e.g., computerised units having an architecture as shown in FIG. 6, as well as non-conventional hardware 100a such as neural processing apparatuses involving crossbar array devices, as discussed in Sect. 1. Each computerised unit 100, 100a is configured to read data from, and write data to, the memory unit of the server computer 2 in this example. Client requests are managed by the unit 2, which may notably be configured to train ANN models as per client requests, or to offload training tasks to any attached computerised unit 100.

The computer system 1 may for instance be configured as a composable disaggregated infrastructure, which may further include other hardware acceleration devices, e.g., application-specific integrated circuits (ASICs) and/or field-programmable gate arrays (FPGAs). Of course, many other architectures can be contemplated. For example, the present system 1 may be configured as a standalone system or as a computerised system connected to one or more general-purpose computers. The system 1 may notably be used in a distributed computing system, such as an edge computing system.

### 3.2 Example of Suitable Computer Unit Architecture (FIG. 6)

In embodiments, the methods described herein are implemented in software, e.g., as one or more executable programs executed by suitable digital processing devices. A suitable computerised unit 100 includes one or more processing elements, such as one or more processors 105 and a memory 110 (meant to act as a main memory), coupled to a memory controller 115. The processors 105 are hardware devices for executing software, as loaded in the main memory of the computerised unit 100. The processors can be any custom made or commercially available processors; they may include graphics processing unit (GPU), which can be leveraged to perform the forward pass more efficiently.

The memory 110 may include a combination of volatile memory elements (e.g., random access memory) and non-volatile memory elements, e.g., solid-state devices. The software in memory may include one or more separate programs, each of which may for instance comprise an ordered listing of executable instructions for implementing logical functions. In the example of FIG. 6, the software in the memory 110 includes methods described herein in accordance with exemplary embodiments and a suitable operating system (OS). The OS essentially controls the execution of other computer (application) programs and provides scheduling, I/O control, file, data and memory management, and communication control as well as related services.

In embodiments, and in terms of hardware architecture, the computerised unit 100 further include one or more input and/or output (I/O) devices 145, 150, 155 (or peripherals) communicatively coupled via a local input/output controller 135. The input/output controller 135 can comprise or connect to one or more buses 140 or other wired or wireless connections. The I/O controller 135 may have additional elements, which are omitted for simplicity, such as controllers, buffers (caches), drivers, and receivers, etc., to enable communications. Further, a local interface may include address, control, and/or data connections to enable appropriate communications among the aforementioned components.

Possibly, a conventional keyboard and mouse can be coupled to the input/output controller 135. I/O devices 145-155 may include other hardware devices, which communicate both inputs and outputs. The computerised unit 100 may further include a display controller 125 coupled to a display 130. In exemplary embodiments, the computerised unit 100 may further include a network interface 160 or transceiver for coupling to a network (not shown).

The methods described herein shall typically be in the form of executable program, script, or, more generally, executable instructions. In operation, one or more of the processing elements 105 execute software stored within the memory 110 (separate memory elements may possibly be dedicated to each processing element), to communicate data to and from the memory 110, and to generally control operations pursuant to software instructions. The methods described herein, in whole or in part are read by one or more of the processing elements 105, typically buffered therein, and then executed. When the methods described herein are implemented in software, the methods can be stored on any computer readable medium for use by or in connection with any computer related system or method.

Computer readable program instructions described herein can be downloaded to processing elements 105 from a computer readable storage medium, via a network, for example, the Internet and/or a wireless network. A network adapter card or network interface 160 in the device may receive the computer readable program instructions from the network and forwards the program instructions for storage in a computer readable storage medium 120 interfaced with the processing elements.

### 3.3 Computer Program Products

A computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may for example be an electronic storage device, a magnetic storage device, an optical or electromagnetic storage device, a semiconductor storage device, or any suitable combination of the foregoing. Examples of such storage media include: a hard disk, a random-access memory (RAM), a static random-access memory (SRAM), an erasable programmable read-only memory (EPROM or Flash memory), a memory stick, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fibre-optic cable), or electrical signals transmitted through a wire.

### 3.4 Final Remarks

Aspects of the present invention are described herein notably with reference to a flowchart and a block diagram. It will be understood that each block, or combinations of blocks, of the flowchart and the block diagram can be implemented by computer readable program instructions.

These computer readable program instructions may be provided to one or more processing elements as described above, to produce a machine, such that the instructions, which execute via the one or more processing elements create means for implementing the functions or acts specified in the block or blocks of the flowchart and the block diagram. Such program instructions may also be stored in a computer readable storage medium.

The flowchart and the block diagram in the accompanying drawings illustrate the architecture, functionality, and operation of possible implementations of computerised systems, methods of operating it, and computer program products according to various embodiments of the present invention.

Each computer-implemented block in the flowchart or the block diagram may represent a module, or a portion of instructions, which comprises executable instructions for implementing the functions or acts specified therein. In variants, the functions or acts mentioned in the blocks may occur out of the order specified in the figures. For example, two blocks shown in succession may actually be executed in parallel, concurrently, or still in a reverse order, depending on the functions involved and the algorithm optimisation used. Furthermore, each block and combinations thereof can also be adequately distributed through special-purpose hardware components.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated. For example, other architectures may be contemplated, whether for the system 1 of the computerised units 100 that form part of the system 1.

1. A computer-implemented method of optimising an artificial neural network, or ANN, the method comprising:
loading quantisation parameters and neural parameters of the ANN, wherein the neural parameters include parameters, which have been learned by training the ANN and quantised based on quantisation operations involving said quantisation parameters; and
optimising the ANN by
accessing labelled examples and executing the ANN on the labelled examples accessed, based on current neural parameters of the ANN, to obtain inference results,
optimising the quantisation parameters against an objective function computed according to the obtained inference results and labels of the labelled examples, while keeping at least some of the current neural parameters fixed, and
updating the current neural parameters thanks to said quantisation operations, based on the optimised quantisation parameters.

2. The computer-implemented method according to claim 1, wherein
executing the ANN on the labelled examples comprises quantising outputs of artificial neurons of internal layers of the ANN based on at least some of the quantisation parameters.

3. The computer-implemented method according to claim 1, wherein
the quantisation parameters are independently optimised for each neural layer of the ANN, whereby distinct sets of quantisation parameters are optimised for respective neural layers of the ANN.

4. The computer-implemented method according to claim 1, wherein
said quantisation operations include uniform affine quantisation operations.

5. The computer-implemented method according to claim 1, wherein
the ANN is iteratively optimised by performing several algorithmic cycles, each cycle of the several algorithmic cycles comprising:
accessing the labelled examples and executing the ANN on the labelled examples accessed, according to current neural parameters of the ANN, to obtain inference results and,
optimising the quantisation parameters against the objective function calculated according to the inference results obtained, while keeping at least some of the current neural parameters fixed; and
updating the neural parameters thanks to said quantisation operations, based on the optimised quantisation parameters.

6. The computer-implemented method according to claim 5, wherein
said quantisation operations further include rounding outcomes of uniform affine operations during said each cycle, such that the updated neural parameters are rounded, and
the quantisation parameters are optimised using a straight-through estimator during said each cycle.

7. The computer-implemented method according to claim 5, wherein
the loaded neural parameters include ANN weights, which have been learned prior to loading the quantisation parameters and the neural parameters of the ANN, and
the method further comprises:
identifying a strict subset of the ANN weights according to a given criterion; and
optimising the strict subset of the ANN weights identified against said objective function, in addition to optimising the quantisation parameters, during one or more of the several algorithmic cycles.

8. The computer-implemented method according to claim 7, wherein
said given criterion is defined so as for the identified ANN weights to be a fraction of the ANN weights that are the most impactful toward a given selection objective.

9. The computer-implemented method according to claim 8, wherein
said strict subset of the ANN weights is astatic subset, which is identified, once and for all, during one of the several algorithmic cycles performed.

10. The computer-implemented method according to claim 8, wherein
the strict subset of the ANN weights is identified during a first cycle of the several algorithmic cycles performed.

11. The computer-implemented method according to claim 1, wherein
all of the current neural parameters are kept fixed while optimising the quantisation parameters against the objective function.

12. The computer-implemented method according to claim 1, wherein the method further comprises, prior to loading the quantisation parameters and the neural parameters,
training the ANN to learn the ANN weights, whereby the learned ANN weights form part of said neural parameters, and
quantising at least some of the neural parameters by:
determining the quantisation parameters; and
performing the quantisation operations based on the determined quantisation parameters.

13. The computer-implemented method according to claim 12, wherein
the quantisation parameters are determined according to a post-training quantisation algorithm.

14. The computer-implemented method according to claim 12, wherein
a quantisation-aware training algorithm is used to train the ANN and quantise the neural parameters of the ANN.

15. The computer-implemented method according to claim 12, wherein
the neural parameters are quantised to an n-bit number representation, where n=4, 8, or 16.

16. The computer-implemented method according to claim 1, wherein
the loaded neural parameters include both ANN weights, which have been learned by training the ANN, and activation function parameters, and
the neural parameters are updated thanks to said quantisation operations, so as for the ANN weights and the activation function parameters to be respectively quantised to an n-bit number representation and an m-bit number representation, where m>n.

17. The computer-implemented method according to claim 1, wherein, at optimising the ANN,
the ANN is executed (S33) by a neural processing apparatus, which is physically configured to implement one neural layer of artificial neurons at a time, and
the quantisation parameters are optimised (S34) by one or more processing units in data communication with the neural processing apparatus.

18. A computerised system comprising:
storage means storing labelled examples, as well as quantisation parameters and neural parameters of an artificial neural network, or ANN, wherein the neural parameters are parameters, which have been learned by training the ANN and quantised based on quantisation operations involving said quantisation parameters; and
processing means, which are configured to
instruct to load the quantisation parameters and the neural parameters of the ANN, and
optimise the ANN by
accessing labelled examples and executing the ANN on the labelled examples accessed, based on current neural parameters of the ANN to obtain inference results, in operation,
optimising the quantisation parameters against an objective function computed according to the obtained inference results and labels of the labelled examples, while keeping at least some of the current neural parameters fixed, and
updating the current neural parameters thanks to said quantisation operations, based on the optimised quantisation parameters.

19. A computer program product for optimising an artificial neural network, or ANN, the computer program product comprising a computer readable storage medium having program instructions embodied therewith, the program instructions executable by processing means of a computerised system to cause the latter to:
load quantisation parameters and neural parameters of the ANN, wherein the neural parameters include parameters, which have been learned by training the ANN and quantised based on quantisation operations involving said quantisation parameters; and
optimise the ANN by
accessing labelled examples and executing the ANN on the labelled examples accessed, based on current neural parameters of the ANN, to obtain inference results,
optimising the quantisation parameters against an objective function computed according to the obtained inference results and labels of the labelled examples, while keeping at least some of the current neural parameters fixed, and
updating the current neural parameters thanks to said quantisation operations, based on the optimised quantisation parameters.

20. The computer program product according to claim 19, wherein
the program instructions are further executable to cause the computerised system, upon executing the ANN on the labelled examples, to quantise outputs of artificial neurons of internal layers of the ANN based on at least some of the quantisation parameters, while optimising the ANN.
